(19) United States
(12) Patent Application Publication
(10) Pub. No.: US 2025/0328788 A1
(43) Pub. Date: Oct. 23, 2025

(54) TECHNOLOGIES FOR CONTROLLING ACCESS TO ARTIFICIAL INTELLIGENCE (AI) DATA IN SHARED MEMORY

(71) Applicant: Intel Corporation, Santa Clara, CA (US)

(72) Inventors: Akhilesh S. THYAGATURU, Ruskin, FL (US); Jason M. HOWARD, Portland, OR (US); Gurpreet Singh KALSI, Portland, OR (US)

(21) Appl. No.: 19/255,650

(22) Filed: Jun. 30, 2025

(51) Int. Cl. G06N 5/04; G06F 21/62

(52) U.S. Cl. CPC G06N 5/04; G06F 21/62; G06F 2221/2141

(57) ABSTRACT

Examples include allocation of a memory region of memory that is accessible to multiple processes of a tenant. In some examples, based on receipt of a first request to access Mixture of Experts (MoE) artificial intelligence (AI) trained weight data from a process associated with a first tenant, apply a configuration to determine whether to permit the access to the trained weight data from a memory and based on a determination to permit the access to the trained weight data, permit the memory to provide trained weight data to the process.

### BACKGROUND

A data center may include one or more computing platforms each comprising at least one processor and associated memory modules. Each computing platform of the datacenter may facilitate the performance of any suitable number of processes associated with various applications running on and/or hosted by computing platform. These processes may be performed by the processors and other associated logic of the computing platforms. Each computing platform may additionally include I/O controllers, such as network adapter devices, which may be used to send and receive data on a network for use by the various applications.

Machine learning (ML) and artificial intelligence (AI) configures computers to learn and make decisions or predictions without being explicitly programmed for every scenario. For example, ML image recognition algorithms can be used to determine which of several categories to which a given input belong; regression algorithms can output a numerical value given an input; and pattern recognition algorithms can be used to generate translated text or perform text to speech and/or speech recognition. Some ML applications rely on large-scale feed-forward models, such as Mixture of Experts (MoE) architectures, which dynamically route data to different processing units (experts).

### BRIEF DESCRIPTION OF THE DRAWINGS

FIG. 1 illustrates an example first system.

FIG. 2 illustrates example controlled shared memory (COSM) management circuitry.

FIG. 3 illustrates an example second system.

FIG. 4 illustrates an example isolation scheme.

FIG. 5 illustrates an example first permission matrix scheme.

FIG. 6 illustrates an example second permission matrix scheme.

FIG. 7 illustrates an example data transfer scheme.

FIGS. 8A-8C illustrate example in-memory compute and isolation schemes.

FIGS. 9A-9C illustrate example processes.

FIGS. 10A-10B illustrate example event sequences.

FIG. 11 depicts an example process.

FIG. 12 depicts an example system.

### DETAILED DESCRIPTION

With the rise of AI-driven cloud services, federated learning, and real-time inference models, unregulated access to shared AI inference databases can expose sensitive data to unauthorized applications. Enforced memory isolation can prevent unauthorized data access, ensuring that only specific AI applications can access defined levels of the dataset. According to various examples described herein, AI applications can utilize secure, multi-tenant access to a common data repository without exposing sensitive training and inference data to unauthorized access. When granted permission, AI models can selectively pull multi-level training and inference data based on workload demands to feed-forward databases.

For example, a Controlled Shared Memory (COSM) framework, described herein, provides circuitry-based isolation of data in memory for secure data access by AI applications. Various examples permit AI systems with multiple applications to access and share AI-relevant data to permitted accessors via COSM.

The Mixture of Experts (MoE) model enables efficient artificial intelligence (AI) inference operations by routing different data to specialized expert networks. Metadata in Mixture of Experts (MoE) models can provide for routing, balanced computation, and informed performance analysis contributing to the model's effectiveness. Metadata can include: expert specialization such as details on the type of data or tasks each expert is trained to handle, routing information for parameters from the gating network that determine expert selection for a given input, load balancing data can include metrics used to ensure even distribution of workload across experts, performance metrics can include evaluation data on how each expert performs on its assigned tasks, or capacity information can include resource usage and parameter counts for each expert.

AI models can be trained in multiple environments by incremental training using the data to train neural networks and corresponding weight and bias data. Various examples of AI systems dynamically assign AI workloads to different expert networks of an MoE. The weighted sum of the outputs from selected experts contribute to AI decision-making. By integrating COSM with AI data-sharing models, efficient multi-level data access can occur for MoE while enforcing access policies. Data access policies can be utilized to protect classified training data and weights.

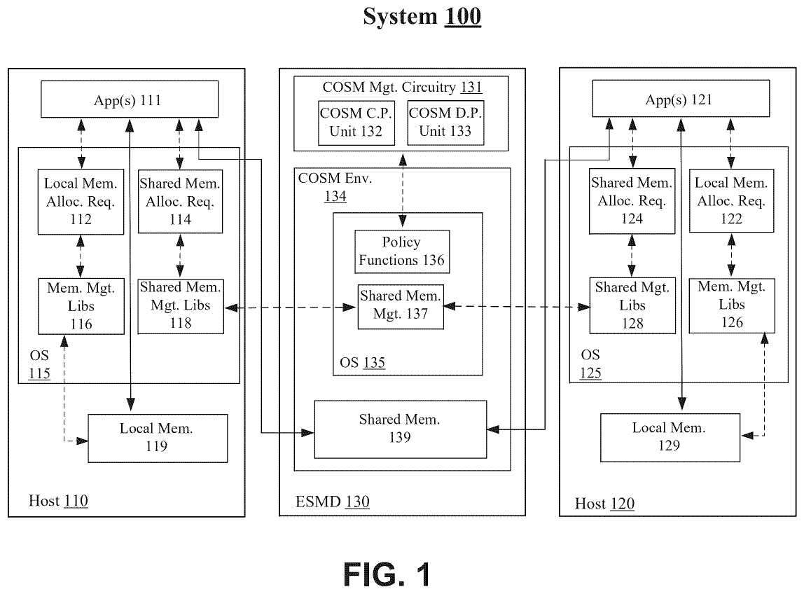

FIG. 1 illustrates an example system 100. According to some examples, as shown in FIG. 1, system 100 includes a host 110, a host 120 and an externally attached shared memory device (ESMD) 130. Also as shown in FIG. 1, host 110 can be configured to host one or more applications (App(s)) 111, an operating system (OS) 115 and maintain or include a local memory 119. Also, host 120 can be similarly configured to host one or more applications 121, an OS 125 and maintain or include a local memory (mem.) 129. In some examples, application(s) 111 and application(s) 121 can place a respective local memory (mem.) allocation (alloc.) request (req.) 112, 122 to respective OSs 115, 125 for use of and/or access to one or more memory regions maintained in respective local memories 119, 129. For these examples, OS 115 and OS 125 can use their respective memory (mem.) management (mgt.) library (libs.) 116, 126 to allocate memory regions maintained in respective local memories 119, 129 to allow application(s) 111 and 121 to access these respective local memories.

According to some examples, as shown in FIG. 1, ESMD 130 includes controlled shared memory (COSM) management (mgt.) circuitry 131, an OS 135 and shared memory 139. Also as shown in FIG. 1, and described in more detail below, COSM management circuitry 131 can include a COSM control plane (C.P.) unit 132 and a COSM data plane (D.P.) unit 133 that can be arranged or configured to set up and implement/enforce an isolation mechanism for access to one or more shared memory regions maintained in shared memory 139. A COSM environment (env.) 134 can be established at ESMD 130 by COSM management circuitry 131 that can include OS 135 implementing policy functions 136 and shared memory (mem.) management (mgt.) 137 for access to one or more memory regions maintained in shared memory 139 based on the isolation mechanism that can include two levels. This two-level mechanism, as will be described more below, can include host-level access control as a first level and data-level inspection and enforcement as a second level. For example, respective application(s) 111, 121 can place a respective shared memory allocation request 114, 124 to respective OSs 115, 125 for use of and/or access to the one or more memory regions maintained in shared memory 139. OSs 115, 125 can be configured to coordinate with shared memory management 137 via establishment of respective shared memory (mem.) management (mgt.) libraries (libs) 118, 128 to enable application(s) 111 or application(s) 121 to access one or more memory regions maintained in shared memory 139 based, at least in part, on policy or rules enforced by policy functions 136.

According to some examples, shared memory 139 can include in-memory compute logic or circuitry (not shown) capable of executing sensitive computations within memory buffers maintained in shared memory 139. These memory buffers can have a self-destructive capability that automatically erases data associated with the computations executed by the in-memory compute logic or circuitry. This self-destructive capability can prevent persistence of data associated with the computations executed by the in-memory compute logic or circuitry and can prevent or reduce a risk of an unauthorized retrieval of this data.

Local memories 119, 129 or shared memory 139 can include volatile and/or non-volatile types of memory. In some examples, local memories 119, 129 or shared memory 139 can include one or more dual in-line memory modules (DIMMs) that are arranged to include any combination of volatile or non-volatile memory. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random-access memory), or some variant such as synchronous DRAM (SDRAM). Local memories 119, 129 or shared memory 139, for example, can include volatile memory compatible with a number of memory technologies.

According to some examples, as mentioned above, local memories 119, 129 or shared memory 139 can include various types of non-volatile memory.

Although not shown in FIG. 1, host 110, host 120 or ESMD 130 may include additional components that facilitate inter-process communications and use of shared memory 139. For example, various network and/or internal communication interfaces and associated interconnects can communicatively couple the elements shown in FIG. 1 to each other or to elements on other hosts or ESMDs (not shown in FIG. 1).

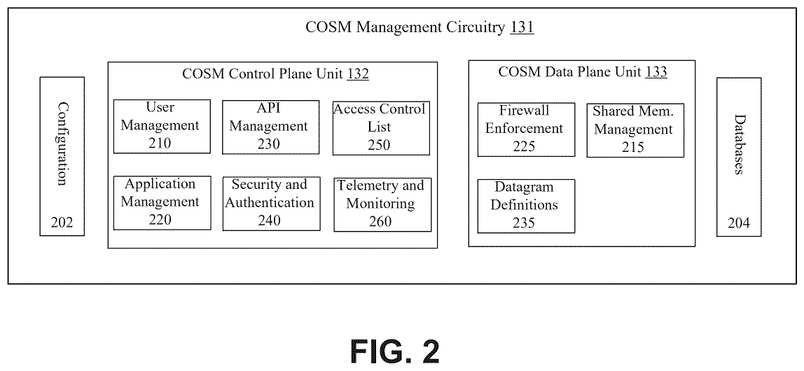

FIG. 2 illustrates example COSM management circuitry 131. In some examples, FIG. 2 shows example logical modules, configurations or databases that can be implemented by hardware circuitry, firmware, and/or software executed on an ESMD such as ESMD 130. For these examples, The COSM management circuitry 131 may include a COSM control plane unit 132 and a COSM data plane unit 133. The COSM control plane unit 132 may be responsible for managing the configuration and establishment of memory-based communication channels in ESMD 130. With a memory-based communication channel configured, the COSM data plane unit 133 may manage operation of the memory-based communication channel following configuration, enforcing isolation policies and providing services to be used in the respective memory-based communication channels based on the configurations.

According to some examples, ESMD 130 can include two or more I/O ports to couple to devices representing different hosts or host domains. A domain can be defined as a set of system resources (e.g., hosts), to which certain users can have prescribed access rights as governed by security policies or service level agreements. The COSM control plane unit 132 can interface with the attached devices to present ESMD 130 as a memory device (e.g., sharable memory device) accessible by the attached devices via their respective interconnect. For example, interconnects arranged to operate using peripheral component interface express (PCIe) protocols, compute express link (CXL) protocols, Ethernet protocols and/or other type of interconnect protocols. User management 210 can be arranged to identify a particular device, operating system, hypervisor, etc. of a host or host domain and determine attributes of the corresponding host and/or host domain, including policies and configurations to be applied for the host and/or host domain. User management 210 can further identify various applications (e.g., applications, services, processes, virtual machines, or threads) that can run on the host or host domain's OS or hypervisor and that may utilize communication channels implemented by ESMD 130. Application management 220 may identify, for the applications of each host and/or host domain, attributes, permissions, policies, and preferences for the applications so as to configure the manner in which individual applications can access and use memory-based communication channels (and their corresponding buffers or memory regions) implemented in ESMD 130. For instance, a single buffer/memory region or memory-based communication channel configured in ESMD 130 (e.g., maintained in shared memory 139) to enable communication between two or more host and/or host domain devices can be called upon, in some examples, to be used by multiple, distinct applications of a host and/or host domain, and application management 220 can configure the memory-based communication channel to establish isolation rules and policies that can govern how or if the applications share the memory-based communication channel, among other example configurations and considerations.

Continuing with the example of FIG. 2, API management 230 can be provided in some implementations to assist in configuring ESMD 130 and respective memory-based communication channels configured in ESMD 130 to interoperate in a system where ESMD 130 couples through an external switch or another ESMD to one or more host or host domains, with the memory-based communication channel being configured to consider the routing, protocols, and other attributes of the potential one-to-many coupling of ESMD 130 to potentially multiple distinct host or host domains through a single input/output (I/O) interface of ESMD 130, among other examples. Security and authentication 240 can be arranged to define and enforce security and authentication protocols (e.g., at the host, host domain or application level) for the memory-based communication channels, such that specific security features and/or policies are configured for the memory-based communication channels. Further, an access control list 250 can govern types of allowed or non-allowed accesses to ESMD 130. For example, enforcing access controls and permissions of the configuration port of an ESMD such as ESMD 130. Telemetry monitoring can also be managed for memory-based communication channels of specific hosts, host domains and/or applications. For instance, in accordance with QoS guarantees for various domains or applications. Telemetry monitoring access can be controlled using telemetry monitoring manager 260, among other example modules and logical blocks.

COSM management circuitry 131 of an example ESMD such as ESMD 130 can additionally include COSM data plane unit 133 to govern the operation of various memory-based communication channels (and corresponding buffers or memory regions) configured in the shared memory maintained at ESMD 130 (e.g., shared memory 139) in accordance with configurations 202. Configurations 202, for example, can be set or implemented using COSM control plane unit 132. Individual buffers, memory regions and memory-based communication channels can have respective functionality, rules, protocols, and policies defined for the channel, and these channel or buffer definitions may be recorded within database 204. The COSM data plane unit 133 may include, for instance, shared memory management 215 to identify one or more portions of shared memory (e.g., buffers or memory regions) and associated in-memory compute logic or circuitry maintained at ESMD 130 to allocate for a specific memory-based communication channel and define pointers to provide to the host or host domain devices that are to communicate over the memory-based communication channel to enable the devices' access to the memory-based communication channel. Shared memory management 215 can leverage these pointers to effectively “turn off” or at least limit a device's or application's access and use of the memory-based communication channel by retiring the pointer, disabling the device's ability to write data on the buffer (to send data on the memory-based communication channel) or read data from a buffer (to receive/retrieve data on the memory-based communication channel), among other example functions. Other security and data filtering functions may be available for use in a memory-based communication channel, based on the configuration and/or policies applied to the memory-based communication channel, such as firewalling by firewall enforcement 225 (e.g., to enforce policies that limit certain data from being written to or read from a buffer or memory region) or data filtering (e.g., at the field level) associated with datagram definitions 235.

Datagram definition 235 can be based on a data format of data written to or read from the memory-based communication channel (e.g., based on a protocol or other datagram format (including proprietary data formats) defined for the memory-based communication channel), to identify the presence of certain sensitive data to filter or redact such data and effectively protect such information from passing over the memory-based communication channel (e.g., from a more secure or higher trust domain to a less secure or lower trust domain), among other examples.

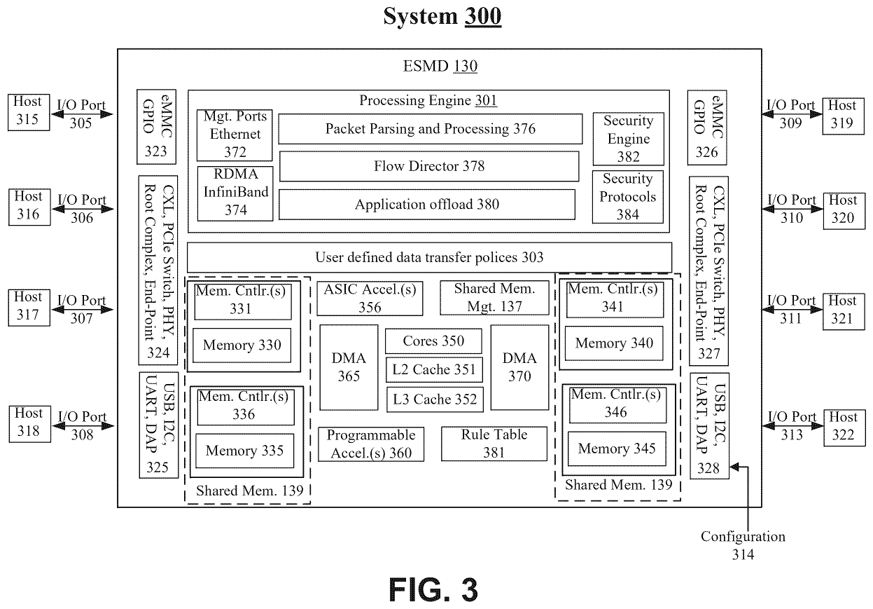

FIG. 3 illustrates an example system 300. According to some examples, as shown in FIG. 3, system 300 includes ESMD 130 coupled with a different set of hosts 313-322 through separate I/O ports 305-313. Hosts 315-322 can be associated with two or more different domains (e.g., domains of different ownership, trust levels, security features or permissions, etc.). Different interconnect protocols may be supported by the various I/O ports 305-313 of ESMD 130 (such as PCIe, CXL, Ethernet, ultra path interconnect (UPI), universal chiplet interconnect express (UCIe), NVLink, embedded multi-media controller (eMMC), general purpose I/O (GIPO), universal serial bus (USB), inter-integrated circuit (I2C), universal asynchronous receiver transmitter (UART), debug adaptor protocol (DA), etc.) and corresponding protocol logic (e.g., 323-324) may be provided on ESMD 130 to enable ESMD 130 to connect to, train, and communicate with the hosts 315-322 over corresponding links.

In some examples, one of the ports from among I/O ports 305-313 or an additional I/O port can be provided as a configuration channel 314, to enable a user or system to interface with ESMD 130 and configure functionality of the ESMD 130, define configurations for connections and communication with ESMD 130 (e.g., by hosts 315-322), define policies and rules that may be applied to memory-based communication channels implemented on ESMD 130, configure cross-domain and/or shared memory services provided by or through the hardware, firmware, and/or software executed on the ESMD 130, among other example features.

According to some examples, as mentioned briefly above for FIG. 1, ESMD 130 can also include shared memory 139. Shared memory 139 can include one or more memory elements (e.g., memory 330, 335, 340, 345), at least a portion of which can be offered as shared memory and implement buffers or memory regions through which two-level isolation schemes can be applied to implement memory-based communication channels between applications or processes hosted by two or more hosts (e.g., 315-323) or by a same host through an exchange of data over or through one or more shared buffers or memory regions. Portions of memory 330, 335, 340, 345 arranged to maintain memory regions or buffers designated for use as shared memory may be presented by ESMD 130 to hosts 315-322 as shared memory (e.g., using semantics of the corresponding interconnect protocol through which the host device connects to ESMD 130). Shared memory management 137 of ESMD 130 can be arranged to coordinate access to the shared memory by hosts 315-322 in cooperation with corresponding memory controllers 331, 336, 341, 346. That coordinated access can include performance of read or write memory operations on respective memory elements memory 330, 335, 340, 345. Also, in-memory compute logic or circuitry (not shown) can be integrated into one or more memory elements 330, 335, 340 or 345 to execute workloads involving sensitive data and use of one or more self-destructive buffers included in these one or more memory elements to ensure data persistence is minimized for that sensitive data. ESMD 130 can further include direct memory access (DMA) engines 365 or 370 to enable direct memory access (e.g., DMA reads and writes) by hosts 315-322) coupled to ESMD 130 and utilizing one or more memory regions or buffers of shared memory 139 for memory-based communication channels.

In some examples, one or more central processing unit (CPU) processor cores 350 can be provided on ESMD 130 to execute instructions and processes to implement the memory-based communication channel via use of one or more memory regions or buffers maintained in shared memory 139 in order to provide various cross domain services in connection with these one or more memory regions or buffers. The various cross domain service can be based on a respective configuration, isolation rules, and/or isolation policies defined for the one or more memory regions or buffers). The isolation rules and/or isolation policies can be maintained, for example, in rule table 381 at ESMD 130. A cache hierarchy that includes level-2 (L2) cache 351 and level-3 (L3) cache 352 can be provided, and cores 350 can be arranged to cooperate and interoperate with other processing/compute elements provided on the ESMD 130 such as one or more application specific integrated circuit (ASIC) accelerators (accel. (s)) 356 (e.g., cryptographic accelerators, error correction and detection accelerators, etc.) and various programmable hardware accelerators 360 (e.g., graphics accelerators (e.g., GPU), networking accelerators, machine learning accelerators, matrix arithmetic accelerators, field programmable gate array (FPGA)-based accelerators, etc.). In addition to in-memory compute logic/circuitry being included in at least some memory elements of shared memory 139, specialized processing functionality and acceleration capabilities (e.g., provided by ASIC accelerator(s) 356 or programmable accelerator(s) 360, etc.) can be leveraged to support memory-based communication channels provided through sharing one or more memory regions or buffers maintained in shared memory 139 of ESMD 130, based on configurations and rules defined for the memory-based communication channel (e.g., maintained in rule table 380).

According to some examples, logic and/or features can be provided on ESMD 130 to implement various cross domain services in connection with a memory-based communication channel established between hosts 315-322 via use of one or more memory regions or buffers maintained in shared memory 139. Such logic and/or features can be implemented in hardware circuitry (e.g., of accelerator devices (e.g., 356, 360), functional IP blocks, etc.), firmware or software (e.g., executed by cores 350). For these examples, functional cross domain service modules can thereby be implemented, such as modules that assist in emulating particular protocols, corresponding packet processing, and protocol features in a given memory-based communication channel (e.g., providing Ethernet-specific features (e.g., Dynamic Host Configuration Protocol (DHCP)), etc.) using an Ethernet port management module (e.g., 372), or remote DMA (RDMA) and InfiniBand features using an RDMA and/or InfiniBand module (e.g., 374). Various packet parsing and processing may be performed at ESMD 130 using, for example, packet parsing and processing 376, for instance, to parse packets written to a memory-based communication channel shared memory region or buffer and performing additional services on the packet to modify the packet or prepare the packet for reading by another host or device coupled to the memory-based communication channel shared memory region or buffer. Application management tasks may also be performed, including routing tasks (e.g., using a flow director 378) to influence the manner in which data communicated over a memory-based communication channel shared memory region or buffer is consumed and routed by the host or host domain receiving the data (e.g., specifying a process, core, virtual machine (VM), etc. at the host that should handle further processing of the data (e.g., based on packet inspection performed at ESMD 130), among other examples. Application offload 380 can be used to leverage information concerning a network connection of one of the hosts coupled to ESMD 130 to cause data read by the host to be forwarded in a particular manner on a network interface controller or other network element on the device (e.g., to further forward the data communicated over ESMD 130 supported memory-based communication channel to other hosts over the network). In other examples, ESMD 130 can perform various security services on data written and/or read from a memory-based communication channel shared memory region or buffer implemented on ESMD 130, for instance, applying custom or pre-defined security policies or tasks (e.g., using a security engine 382), applying particular security protocols to the communications carried over/through the memory-based communication channel shared memory region or buffer (e.g., IPSec using security protocols 384), among other example cross domain services and functionality.

According to some examples, an internet protocol (IP) network can be at least partially replaced using one or more (or a network of) ESMDs. For these examples, ESMDs such as ESMD 130 can be utilized to implement cross-domain collaboration that allows information sharing to become more intent-centric. For instance, one or more applications executed in a first domain at a first host and the transactions required for communications with other applications of a different domain at the first host or a second host can be first verified for authenticity, security, or other attributes (e.g., based on an application's or domain's requirements), thereby enforcing implicit security. Memory-based communication can also offer a more reliable data transfer and simpler protocol operations for retransmissions and data tracking (e.g., than a more conventional data transfer over a network or interconnect link (which may be emulated by the memory-based communication). Through such simpler operations, ESMDs solutions can offer high-performance communication techniques between interconnecting domain-specific computing environments. Further, memory interfaces in an ESMD can be enforced with access controls and policies for secure operations, such as implementing a permission matrix scheme that can include a type of data-diode which cause memory-based communication channels to operate in a unidirectional fashion with permission-based access controls, such as write-only access, read-only access, and read/write access to access one or more memory-based communication channel shared memory regions or buffers. In other instances, a memory-based communication interface maintained by the ESMD can enable bi-directional communication between different hosts or different host domains. In some examples, separate memory regions or buffers can be used to facilitate each direction of communication (e.g., one memory region/buffer for communication from host A to host B and another memory region/buffer for communication from host B to host A). In such cases, different policies, cross domain services, and even protocols can be applied to each memory region/buffer, based on the disparate characteristics and requirements of the different hosts or host domains, among other example implementations. Generally, these memory-based communication interfaces can be a standard implementation and can also be open-sourced for easier use, community adoption, and public participation in technology contributions without compromising the security and isolation properties of the data transactions. The open implementation also provides transparency of communication procedures over open interfaces to identify any security vulnerabilities.

An ESMD can enable support for application-defined communication protocols over open interface definitions (and open implementation), allowing customized communication solutions, which are wholly independent of or at least partially based on (and emulate) interconnect protocols. For instance, application-defined communication protocols may enable applications to create their own datagram format, segmentation, encryption, and flow control mechanisms that are decoupled from the protocols used in the ESMD memory-based communication channel interfaces (connecting the ESMD to hosts).

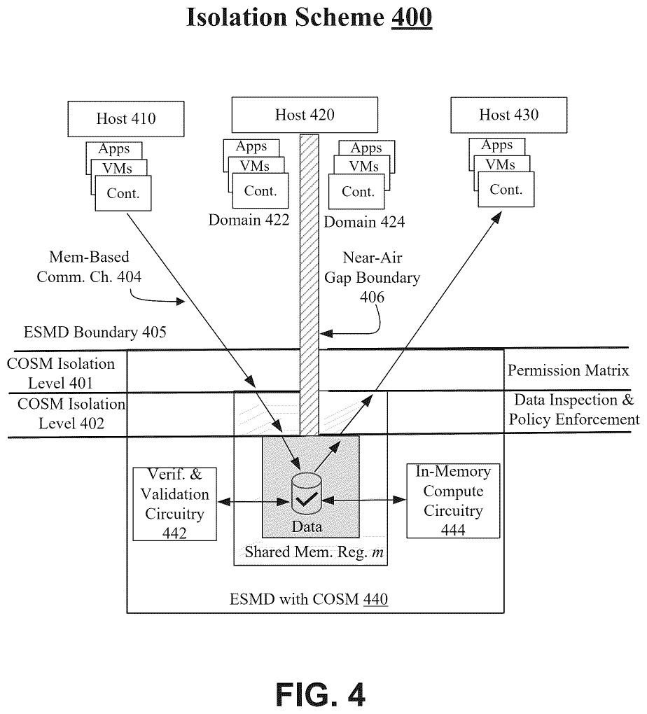

FIG. 4 illustrates an example isolation scheme 400. In some examples, hosts 410, 420 or 430 may be arranged to share access to a shared memory region m maintained at an ESMD with COSM 440. Although not shown in FIG. 4, ESMD with COSM 440 can be configured and/or include similar COSM management circuitry as shown in FIG. 2 for COSM management circuitry 131 and similar functional hardware and logic/features as shown in FIG. 3 for ESMD 130. For these examples, isolation scheme 400 can include establishment of a memory-based communication channel 404 to enable applications, VMs or containers (conts.) hosted by host 410 and host 430 to read and/or write data to shared memory region m based, at least in part, on a first COSM isolation level 401 and a second COSM isolation level 402.

In some examples, as shown in FIG. 4, ESMD with COSM 440 can also include verification (Verif.) & validation circuitry 442 and in-memory compute circuitry 444. Verification & validation circuitry 442 and in-memory compute circuitry 444 can be integrated or embedded within memory elements that maintain or include shared memory region m. In some examples, for in-memory compute operations, shared memory region m can operate according to an in-memory compute technology that can be based on SRAM, DRAM, flash memory, resistive RAM (ReRAM), PCM, FeTRAM, or MRAM. The in-memory compute technology can also be based on analog computations or digital computations for in-memory compute operations. In some examples, verification & validation circuitry 442 can be included in COSM management circuitry (e.g., as part of COSM data plane unit) and in-memory compute circuitry 444 can be integrated or embedded within memory elements that maintain or include shared memory region m. For either of these examples, sensitive workloads can be executed directly within shared memory region m and shared memory region m can be arranged to implement buffer destruction mechanisms to cause data associated with execution of the sensitive workloads to be automatically erased after verification & validation circuitry 442 has validated post-execution computations of the sensitive workloads by in-memory compute circuitry 444. Verification and validation can include use of error correction codes such as parity bits or cyclic redundancy check (CRC) to determine if calculated results have errors (e.g., caused by bit flips during in-memory compute operations). The sensitive workloads, for example, can be required by applications, VMs or containers hosted by host 410, 420 or 430 and computations performed by in-memory compute circuitry can include, but are not limited to, encryption computations, checker computations, or decryption computations.

According to some examples, COSM isolation level 401 can be based on a permission matrix scheme that can be arranged to either permit or block applications, VMs or containers hosted by host 410 or host 430 to read/or write data to shared memory region m. For example, the permission matrix can permit applications, VMs or containers hosted by host 410 to conduct at least write operations to shared memory region m and permit applications, VMs or containers hosted by host 430 to conduct at least read operations to shared memory region m. COS isolation level 401 can be implemented at ESMD boundary 405 to allow or block write operations from host 410 or read operations from host 430.

In some examples, COSM isolation level 402 can be based on data inspection and policy enforcement associated with data to be written to or read from shared memory region m. Data inspection and policy enforcement can include inspecting each data transaction (e.g., memory write or read operation) to shared memory region m before that data transaction is processed. For example, policies can be enforced that can include, but are not limited to, verifying a data format and security associated with the data transaction (e.g., ensuring encrypted payloads, structured database records, compliance with industry regulations) and allowing the data transaction if compliant to the policies or taking policy-based actions if the data transaction is not compliant to the policies. Policy-based actions can include, but are not limited to, modifying, deleting, blocking, or generating a notification to a management entity (e.g., a system management orchestrator) to indicate that a non-compliant data transaction was detected for accessing shared memory region m.

According to some examples, a second memory-based communication channel (not shown) similar to memory-based communication channel 404 can be established between two domains 422 and 424 hosted by host 420. For these examples, the second memory-based communication channel can be subject to the same two-level isolation scheme that effectively creates a near-air gap boundary 406 between applications, VMs and containers included in domain 422 and applications, VMs and containers included in domain 424. The near-air gap boundary 406 is shown in FIG. 4 to indicate that a two-level isolation scheme such as example isolation scheme 400 can emulate an air-gap (physical isolation) of shared memory region m when shared between two domains or shared between two hosts hosting respective domains.

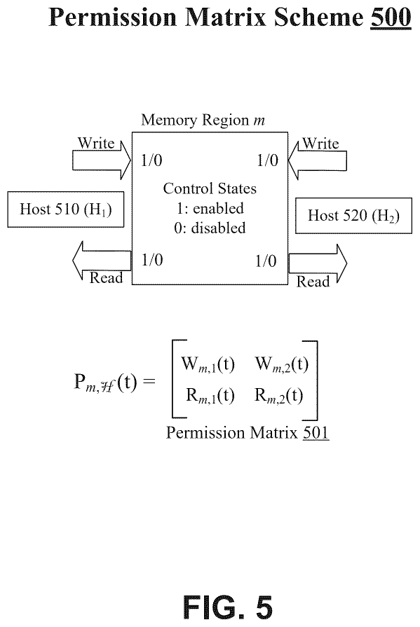

FIG. 5 illustrates an example permission matrix scheme 500. According to some examples, example permission matrix scheme 500 can represent a portion of a controlled shared memory (COSM) framework implemented at an ESMD. For these examples, permission matrix scheme 500 includes use of permission matrix 501 for fine-grained filtering and control at the granularity of individual hosts that are shown in FIG. 5 as host 510 and host 520 and at the granularity of an individual memory region shown in FIG. 5 as memory region 539. Memory region 539, for example, is maintained at the ESMD and is arranged to be shared by host 510 and host 520. For example permission matrix 501, “Pₘ” indicates that this is a permission matrix for shared memory region m and “H” denotes a set of distinct hosts {H₁, H₂, . . . , Hₙ, . . . , H_{N}} that can participate in permission matrix scheme 500 and “m” denotes a set of distinct (non-overlapping) memory regions [M₁, M₂, . . . , Mₘ, . . . , M_{M}]. A given memory region Mₘ can be characterized by a memory address of the start of memory region Mₘ and a memory address of the end of memory region Mₘ.

In some examples, memory region 539 can represent a given memory region Mₘ. and host 510 can represent a given host H₁ and host 520 can represent a second given host H₂. For these examples, host 510 and host 520 can be configured for sharing memory region 539 based on an underlying memory technology or standard (e.g., CXL). Both host 510 and host 520 can have two degrees of freedom for sharing memory region 539: write permission and read permission, which may change with time t. The variable “t” indicates a type of time-dependent control of shared memory region 539. For example permission matrix 501, if W_{m,1}(t)=1, host 510 (H₁) is permitted to write data to memory region 539 (m) at time t and if W_{m,1}(t)=0, host 510 (H₁) is blocked or prohibited from writing data to memory region 539 (m) at time t. Also, if R_{m,1}(t)=1, host 510 (H₁) is permitted to read data from memory region 539 (m) at time t and if R_{m,1}(t)=0, host 510 (H₁) is blocked or prohibited from writing data to memory region 539 (m) at time t. Similarly, if W_{m,2}(t)=1, host 520 (H₂) is permitted to write data to memory region 539 (m) at time t and if W_{m,2}(t)=0, host 520 (H₂) is blocked or prohibited from writing data to memory region 539 (m) at time t. Also, if R_{m,2}(t)=1, host 520 (H₂) is permitted to read data from memory region 539 (m) at time t and if R_{m,2}(t)=0, host 520 (H₁) is blocked or prohibited from writing data to memory region 539 (m) at time t.

According to some examples, permission matrix 501 can be used as a mechanism to ensure that hosts 510 or 520 can access shared memory region 539 with tailored read/write permissions. For example, shared memory region 539 may be a critical shared memory region and host 510 may need to perform real-time updates to data maintained in shared memory region 539 to perform real-time updates and thus may have write access to shared memory region 539, while other hosts such as host 520 are restricted to read-only permissions to prevent accidental overwrites or data corruption. This type of fine-granular control enables precise enforcement of access policies, minimizing risks of unauthorized data manipulation or accidental interference in multi-host environments.

In some examples, permission matrix 501 can allow for a type of permission matrix filtering that facilitates dynamic and context-aware memory management. For example, an ESMD such as ESMD 130 can be configured to update permissions on the fly based on an operational state of a system or based on application requirements. Updated permissions can include granting temporary write access to a host for a specific task and then revoking the permission once the task is complete. This type of flexibility can be important in scenarios involving hierarchical or distributed memory allocation, where different hosts or processes may have varying levels of privilege. By enabling a fine-granular level of control, the ESMD can improve both security and performance by allowing shared memory that can be utilized efficiently without compromising the integrity of data or system operations.

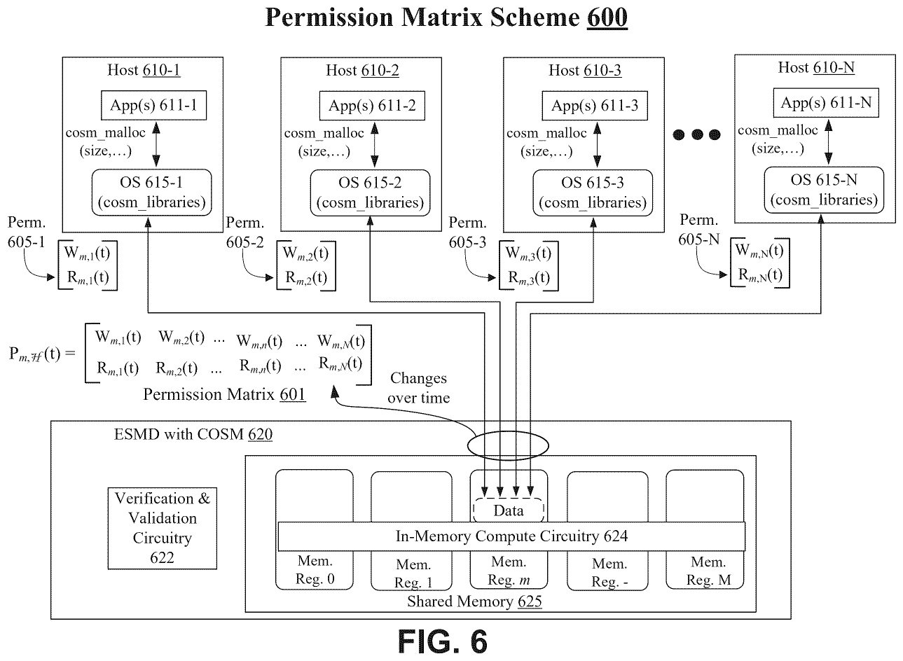

FIG. 6 illustrates an example permission matrix scheme 600. According to some examples, permission matrix scheme 600 shows use of a permission matrix 601 to control access by applications 611-1 to 611-N hosted by Hosts 610-1 to 610N to data maintained in shared memory region (mem. reg.) m maintained at ESMD with COSM 620. Although not shown in FIG. 6, ESMD with COSM 620 can be configured to include similar COSM management circuitry as shown in FIG. 2 for COSM management circuitry 131 and similar functional hardware and logic/features as shown in FIG. 3 for ESMD 130. For these examples, the variables of permission matrix 601 can be used in a similar manner as mentioned above for permission matrix 501 to indicate write or read permissions of hosts 610-1 to 610-N at time t. The individual permissions included in permission matrix 601 are shown in FIG. 6 as permissions 605-1 to 605-N.

In some examples, logic and/or features of COSM management circuitry for ESMD with COSM 620 (e.g., control plane unit 132 of COSM management circuitry 131) can moderate access control to memory region m maintained in memory 625 by setting permissions for each host from among hosts 610-1 to 610-N through permission matrix 601. For these examples, once permissions to access memory region m are completed, applications 611-1 to 611-N can use library functions (cosm_libraries) maintained by respective OSs 615-1 to 615-N to place memory allocation requests (cosm_malloc size, . . . ) to allocate memory addresses and to access those allocated memory addresses via read or write operations.

According to some examples, as shown in FIG. 6, shared memory 625 includes in-memory compute circuitry 624. In-memory compute circuitry 624 can be capable of executing sensitive computations within memory buffers maintained in at least a portion of the memory regions maintained in shared memory 625. Similar to the memory buffers mentioned above for FIG. 4, these memory buffers can have a self-destructive capability that automatically erases data associated with the computations executed by the in-memory compute circuitry 624. This self-destructive capability can prevent persistence of data associated with the computations executed by in-memory compute circuitry 624 and can prevent or reduce a risk of an unauthorized retrieval of this data. Also, prior to implementation of buffer destruction mechanisms to cause data associated with execution of the sensitive workloads to be automatically erased, verification & validation circuitry 622 can configured to validate post-execution computations of the sensitive workloads by in-memory compute circuitry 624.

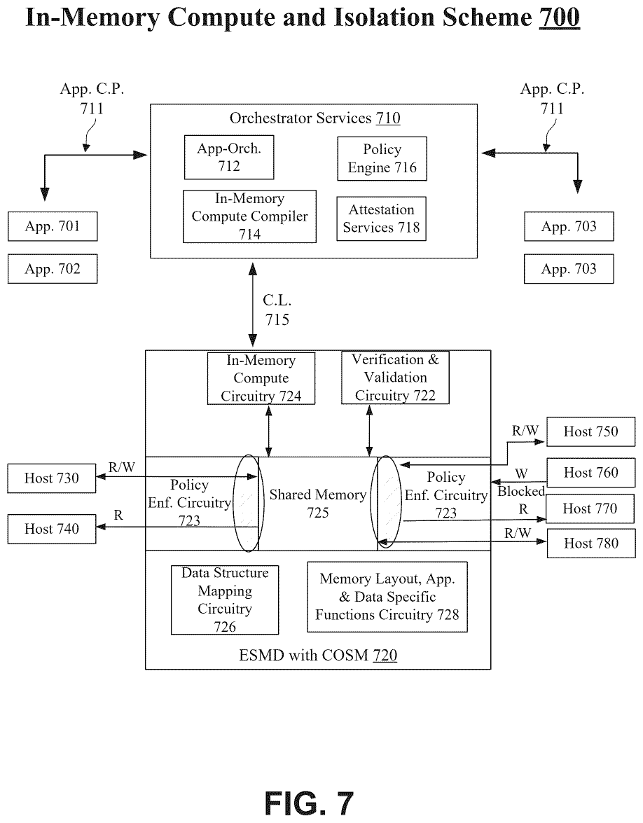

FIG. 7 illustrates an example data transfer scheme 700. In some examples, as shown in FIG. 7, data transfer scheme 700 includes a COSM control plane unit 732 in communication with an ESMD 720 and in communication with hosts 710 and 720. For these examples, although not shown in FIG. 7, COSM control plane unit 732 can be configured to include similar logic and/or features included in COSM control plane unit 132 of COSM management circuitry 131 described above for and shown in FIG. 2. Also, ESMD 720 can include similar functional hardware and logic/features described above for and shown in FIG. 3.

According to some examples, data transfer scheme 700 can illustrate a general approach for an end-to-end data transfer between applications hosted by hosts 710 and 720 via a memory-based communication channel established through shared memory regions of a shared memory maintained at ESMD 720. For example, COSM defined information 703 indicates: (1) transactions control; (2) permissions; (3) memory management; and (4) control functions for memory transactions for this established memory-based communication channel. Item (1) related to transaction control can be related to data inspection and policy enforcement that may be implemented in a similar manner as mentioned above for isolation scheme 400 (COSM isolation level 402). Item (2) related to permissions may be implemented in a similar manner as mentioned above for isolation scheme 400 (COSM isolation level 401) and for permission matrix scheme 500. Item (3) related to memory management can result in host 710 sharing memory regions 1-4 with host 720 and also can result in host 720 having exclusive access to memory region M. Item (4) related to control functions for memory transactions can also be related to data inspection and policy enforcement implemented in a similar manner as mentioned above for isolation scheme 400 (COSM isolation level 402).

In some examples, hosts 710 and 720 can allocate their respective address space that map to shared memory regions 1-4 to applications included in application(s) 711 and 713. For example, host 710 and host 730 address spaces that include memory regions k, l, m, n are mapped to shared memory regions 1-4. Also, host 730's address space q is shown in FIG. 7 as mapping to memory region M that is not shared between hosts 710 and 730. Application A of host 710 can request and receive an allocation of memory region k and l that maps to shared memory region 1 and 2. Similarly, application A of host 730 can request and receive an allocation of memory region k and l that also maps to shared memory region 1 and 2. Also, application B of host 730 can request and receive an allocation of memory region q that maps to memory region M.

According to some examples, data transfers through shared memory regions 1-4 can be conducted with user defined protocol data units (UPDUs). For these examples, applications can determine a data structure to be used for sharing over shared memory regions 0-4. This can allow applications to create UPDUs over the shared memory, whereby applications can define data block specifications, such as data type, block size, and headers. As shown in FIG. 7 for data transfer scheme 700, application defined information item (1) data type, block size, headers can indicate how data block specifications are defined. Also, item (2) can define transaction types (e.g., read/write), item (3) can define a buffer type to use at an ESMD with COSM, and item (4) can define a flow control.

According to some examples, as shown in FIG. 7, shared memory 725 includes in-memory compute circuitry 724. In-memory compute circuitry 724 can be capable of executing sensitive computations within memory buffers maintained in at least a portion of the memory regions maintained in shared memory 725. Similar to the memory buffers mentioned above for FIG. 4, these memory buffers can have a self-destructive capability that automatically erases data associated with the computations executed by in-memory compute circuitry 724. This self-destructive capability can prevent persistence of data associated with the computations executed by the in-memory compute circuitry 724 and can prevent or reduce a risk of an unauthorized retrieval of this data.

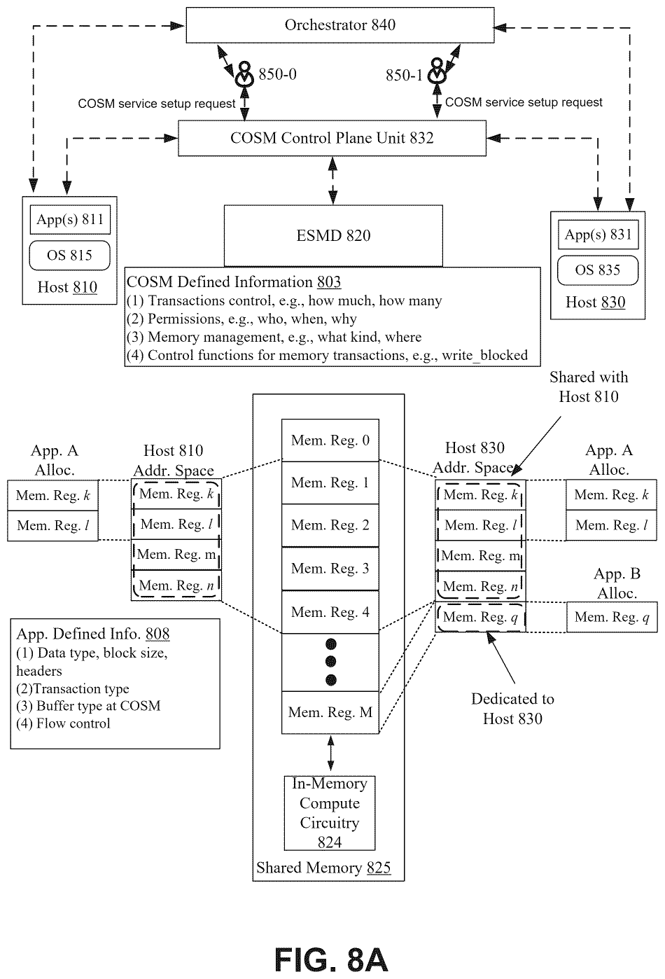

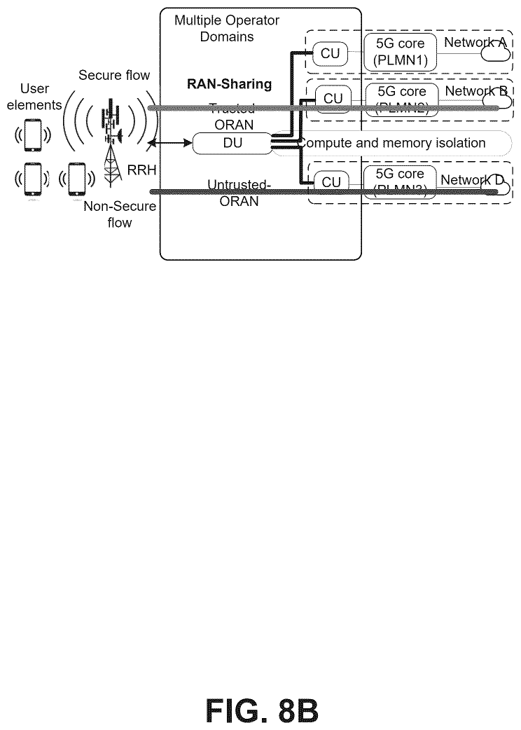

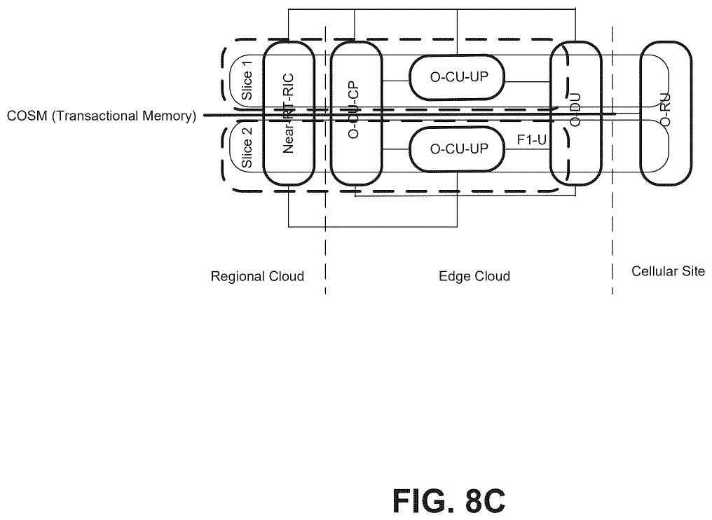

FIG. 8 illustrates an example in-memory compute and isolation scheme 800. In some examples, as shown in FIG. 8, in-memory compute and isolation scheme 800 can include an orchestrator services 810 communicatively coupled with applications 801, 802, 803 and 805 through an application (App.) control plane (C.P.) 811 and communicatively coupled with ESMD with COSM 820 through communication link (C.L.) 815. Although not shown in FIG. 8, ESMD with COSM 820 can be configured to include similar COSM management circuitry as shown in FIG. 2 for COSM management circuitry 131 and similar functional hardware and logic/features as shown in FIG. 3 for ESMD 130.

According to some examples, as shown in FIG. 8, orchestrator services 810 can include an application-orchestrator (App-Orch.) 812, a policy engine 816, an in-memory compute compiler 814, or an attestation services 818. For these examples, application-orchestrator 812 can be configured to communicate with applications 801, 802, 803 or 805 via application control plane 811 to receive in-memory compute requests that include in-memory computations at shared memory 825 maintained at ESMD with COSM 820. Policy engine 816 and/or attestation services 818 can be configured to determine whether a particular application is authorized to request in-memory compute for shared memory 825. If authorized, in-memory compute compiler 814 can be capable of causing in-memory compute circuitry 824 to be configured for in-memory computations based on respectively authorized in-memory compute requests from applications 801, 802, 803 or 805. This configuration of in-memory compute circuitry 824 can also include allocating secure memory buffers included in shared memory 825. The secure memory buffers can at least temporarily store data associated with in-memory compute computations executed by in-memory compute circuitry 824 responsive to authorized in-memory compute requests. According to some examples, this collaboration between ESMD with COSM 820 and orchestrator services 810 for configuring in-memory compute circuitry 825 and shared memory 825 can enforce dynamic, real-time memory access and in-memory compute operations that can protect sensitive data associated with execution of security-sensitive workloads in a multi-tenant infrastructure. This type of dynamic collaboration can be used for multi-tenant environments such as open radio access networks (O-RAN), cloud computing, or industrial automation. For example, radio intelligent controller (RIC) and security management operations (SMOs) can be able to dynamically adapt memory access or in-memory compute enforcement policies based on workload demand.

In some examples, a data structure mapping circuitry 826 maintained at ESMD with COSM 820 can be configured to assist with the mapping of shared memory regions of shared memory 825 to hosts 810 and 830 in a similar manner as described above for data transfer scheme 700. Also, memory layout, application (App.) & data specific functions circuitry 828 can be configured to assist with the memory layout of the shared memory regions of shared memory 825 to facilitate use of shared memory 825 for workloads associated with authorized in-memory compute requests to be executed by in-memory compute circuitry 824. This facilitation can include setting up memory buffers in shared memory 825 to have self-destructive capabilities that automatically erases data associated with the computations executed by in-memory compute circuitry 824. Also, prior to implementation of buffer destruction mechanisms to cause data associated with execution of the sensitive workloads to be automatically erased, verification & validation circuitry 822 can be configured to validate post-execution computations of the sensitive workloads by in-memory compute circuitry 824. In some examples, data structure mapping circuitry 826 and memory layout, application & data specific functions circuitry 828 can be included in COSM management circuitry (e.g., part of a COSM data plane unit) of ESMD with COSM 820.

According to some examples, ESMD with COSM 820 can also include policy enforcement (Enf.) circuitry 823. Policy enforcement circuitry 823 can be configured to implement a similar two-level isolation scheme as described above for isolation scheme 400 that includes use of a first level of isolation that uses a permission matrix similar to permission matrix 601 shown in FIG. 6. Also as described above, the similar two-level isolation scheme can include a second level of isolation that includes data inspection and policy enforcement as mentioned for isolation scheme 400. For example, as shown in FIG. 8, the end point arrow heads between shared memory 825 and hosts 810 and 830, operator 850-0 or 850-1 can indicate what permissions are allowed for a particular host. For this example, operators 850-0 or 850-1 have arrow heads on both end points to indicate permission for read and write memory transactions to shared memory 825. Permission for only read memory transactions from host 810 to shared memory 825 can be granted. Also, a blocked write request can indicate that host 810 does not have write access permission to shared memory 825.

As described herein, ESMD 820 can permit or prevent access to trained weight data from an MoE architecture by particular tenants or processes. As described herein, ESMD 820 can permit or prevent access to training data by particular tenants or processes and can permit or prevent modifying trained weight data in ESMD 820. For example, a control plane can configure ESMD 820 to control writing to COSM or reading from COSM. For example, COSM control plane 832 can populate Access Control List (ACL) of COSM defined information 802. An ACL can include an array of tenant or process ID, memory regions, and a corresponding access level (e.g., top level, medium level, low level, or no access).

Applications 811 and 831 can be assigned different security levels, defining what subset of the dataset they can access. Security policies can define access levels. For example, top access level can provide applications 811 and 831 with full dataset access for deep learning optimizations. For example, medium access level can provide applications 811 and 831 with access to filtered, domain-specific datasets, that is less than the full dataset. For example, least access level can provide applications 811 and 831 with pre-processed, low-level feature data that is less than the dataset available through medium access level.

An exemplary type of machine learning algorithm is a neural network. There are many types of neural networks; a simple type of neural network is a feedforward network. A feedforward network may be implemented as an acyclic graph in which the nodes are arranged in layers. Typically, a feedforward network topology includes an input layer and an output layer that are separated by at least one hidden layer. The hidden layer transforms input received by the input layer into a representation that is useful for generating output in the output layer. The network nodes are fully connected via edges to the nodes in adjacent layers, but there are no edges between nodes within each layer. Data received at the nodes of an input layer of a feedforward network are propagated (e.g., “fed forward”) to the nodes of the output layer via an activation function that calculates the states of the nodes of each successive layer in the network based on coefficients (“weights”) respectively associated with each of the edges connecting the layers. Depending on the specific model being represented by the algorithm being executed, the output from the neural network algorithm can take various forms.

Before a machine learning algorithm can be used to model a particular problem, the algorithm is trained using a training data set. Training a neural network involves selecting a network topology, using a set of training data representing a problem being modeled by the network, and adjusting the weights until the network model performs with a minimal error for all instances of the training data set. For example, during a supervised learning training process for a neural network, the output produced by the network in response to the input representing an instance in a training data set is compared to the “correct” labeled output for that instance, an error signal representing the difference between the output and the labeled output is calculated, and the weights associated with the connections are adjusted to minimize that error as the error signal is backward propagated through the layers of the network. The network is considered “trained” when the errors for each of the outputs generated from the instances of the training data set are minimized.

The accuracy of a machine learning algorithm can be affected significantly by the quality of the data set used to train the algorithm. The training process can be computationally intensive and may require a significant amount of time on a conventional general-purpose processor. Accordingly, parallel processing hardware is used to train many types of machine learning algorithms. This is particularly useful for optimizing the training of neural networks, as the computations performed in adjusting the coefficients in neural networks lend themselves naturally to parallel implementations. Specifically, many machine learning algorithms and software applications have been adapted to make use of the parallel processing hardware within general-purpose graphics processing devices.

Various examples can be utilized to train or re-train machine learning (ML) models at least in MoE systems. Various examples can utilize a memory and circuitry that prevents unauthorized access to training data and weights while allowing incremental learning and modifying weight data across multiple host platforms. Various examples can enforce authentication-based data sharing and access to trained weights in memory. If authentication fails, access is denied, preventing unauthorized access to data or weights. The circuitry can validate incremental training results before merging the results into the trained weight space stored in memory. The memory can store trained model weights and training data to avoid duplication of confidential weight and training data.

ESMD 820 can store trained weights securely and control access to training data and trained weights. ESMD 820 with COSM can authenticate host before sharing training data and trained weights. For example, based on COSM defined information 803, application 811 executing on Host 810 can store training data, trained weights, and MoE metadata in ESMD 820. For example, based on COSM defined information 803, application 831 executing on Host 830 can access the training data, trained weights, and MoE metadata from ESMD 820 and potentially modify the trained weights. For example, an access level of COSM defined information 803 can provide application 831 with full MoE weight access, restricted access to partial weights, or no access to weights. For example, an access level of COSM defined information 803 can provide application 831 with full data access, restricted access to partial data, or no access to data. Incremental training platform (e.g., application 831) executing on Host 830 can perform incremental learning based on training data retrieved from ESMD 820. Updated trained weights can be stored in a ESMD 820, preventing tampering or unauthorized access. If access is not permitted, ESMD 820 can output garbage data and issue an alert to a data center administrator.

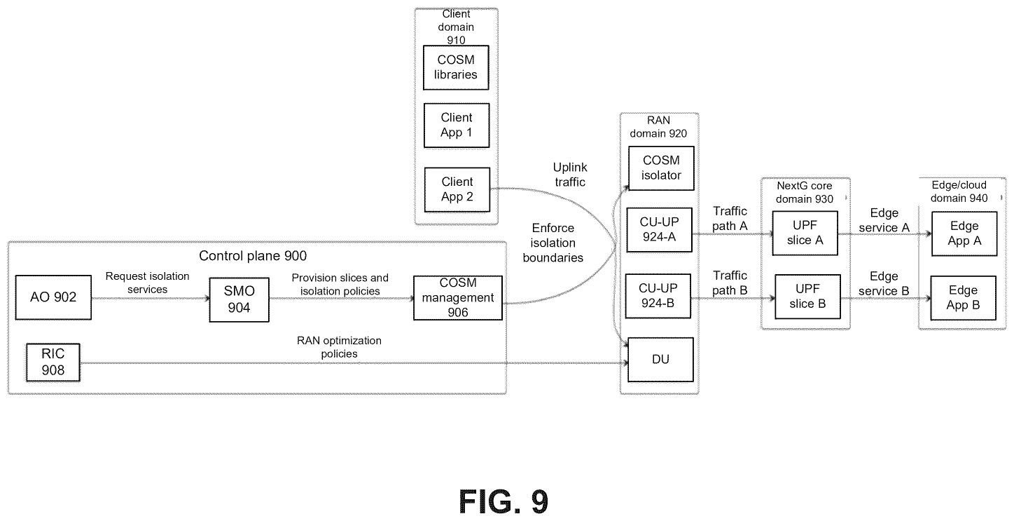

FIG. 9A depicts an example system. Trained weights are stored in COSM-secured memory, ensuring AI model integrity. COSM memory system can enforce memory protection for AI models with dynamic MoE sharing based on clearance levels.

In some examples, a user application executing on Host 1 can generate training data and request to store the training data into the COSM memory system. Based on a permission level for the user application, specifically, or a tenant that executes the user application, COSM memory system can permit or deny a request to store the training data into a memory device. COSM memory system can allow incremental training without requiring multiple copies of the model weights, reducing security risks.

Host 2 can execute an AI model and train the AI model based on previously trained weights stored in COSM memory system and user generated data also stored in COSM memory system and generate updated training weights. Based on a permission level for the AI model, specifically, or a tenant that executes the AI model, COSM memory system can permit or deny a request to store the updated training data into COSM memory system. Weights in a neural network can be numerical values associated with the connections between neurons (or nodes) across different layers of the network. A connection from one neuron to another can have an associated weight that signifies the strength and direction (positive or negative) of the influence one neuron has on another. When an input signal passes through the network, the input signal can be multiplied by these weights, which cumulatively determine the final output of the network.

FIG. 9B depicts an example system. A large language model (LLM) pipeline include various stage norm, multi-head attention, sum, norm, router, or other components. Feedforward Neural Network (FNN) is a type of artificial neural network in which information flows from the input layer through hidden layers to the output layer without loops or feedback.

In MoE architectures, metadata can include operational information that can guide expert selection among Experts 1 to 4. Metadata can include expert specialization including details on the type of data or tasks each expert is trained to handle, routing information including parameters from the gating network that determine expert selection for a given input, load balancing data including metrics used to ensure even distribution of workload across experts, performance metrics including evaluation data on how each expert performs on its assigned tasks, or capacity information including resource usage and parameter counts for each expert. Examples of metadata usage include routing or gating networks use learned metadata to assign tokens to the most suitable experts, load balancing to distribute training loads, or monitoring of performance metadata helps identify optimization opportunities.

Experts 1-4 can include trained feedforward AI models. AI models can be part of a group of MoE and AI models can be trained to provide inference for the same or different subjects. Experts 1-4 can utilize one or more of neural network weights for Experts 0 to n (Exp0 to Expn), where n is an integer, in feed forward models. Weights in a neural network are numerical values associated with the connections between neurons (or nodes) across different layers of the network. Each connection from one neuron to another has an associated weight that signifies the strength and direction (positive or negative) of the influence one neuron has on another. When an input signal passes through the network, it gets multiplied by these weights, which cumulatively determine the final output of the network.

As described herein, a COSM can isolate weights of trained feedforward AI models from access by particular tenants' AI models based on a policy. A policy can define access rights of different tenants and associated AI models. An AI model can access or modify only data authorized to be accessed or modified, preventing unauthorized knowledge extraction.

Weighted outputs from feedforward experts 1 to 4 can be summed together to generate a weighted sum output.

FIG. 9C depicts an example of accesses to datasets for neural network training operations. For example, COSM can store data sets of varying scop of data and based on a policy, a particular expert model can access data to perform training to generate weight data and store the weight data into COSM. For example, data H can represent a high level of available data for neural network training operations, data M can represent a medium level of available data for neural network training operations, and data L can represent a low level of available data for neural network training operations. For example, data H can include data M and data L and additional data not included in data M or data L. For example, data M can include data L and additional data not included in data L. For example, tenant 1 (high access) can access MoE 1, 2, and 3 whereas tenant 2 (medium access) can access only MoE 2 and 3 and tenant 3 (low access) can access only MoE 3.

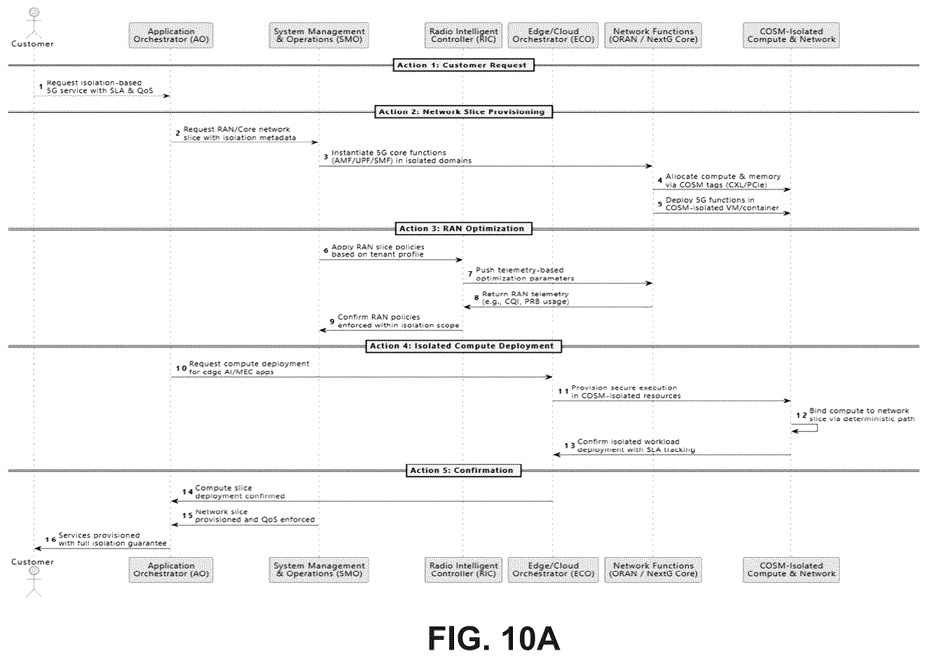

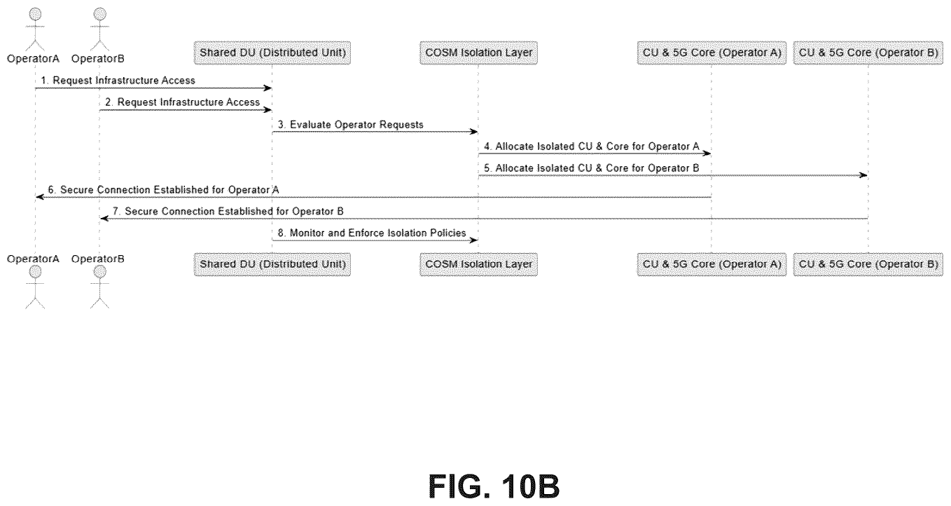

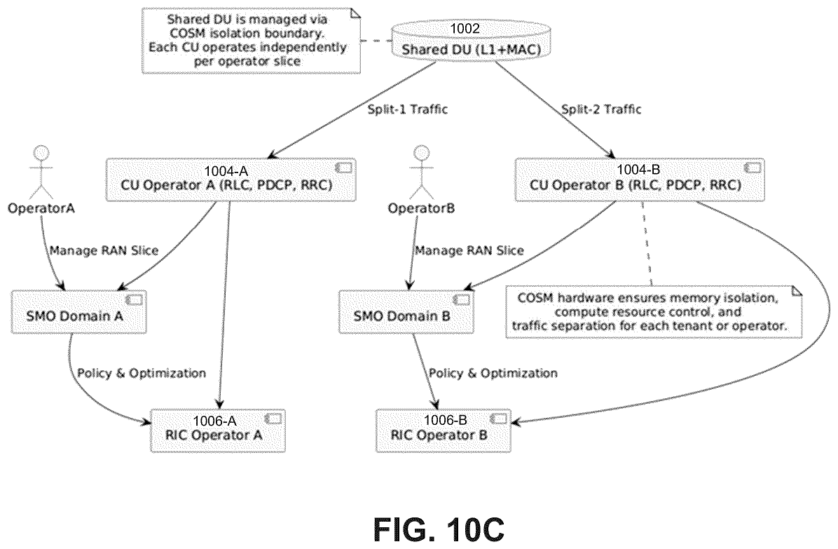

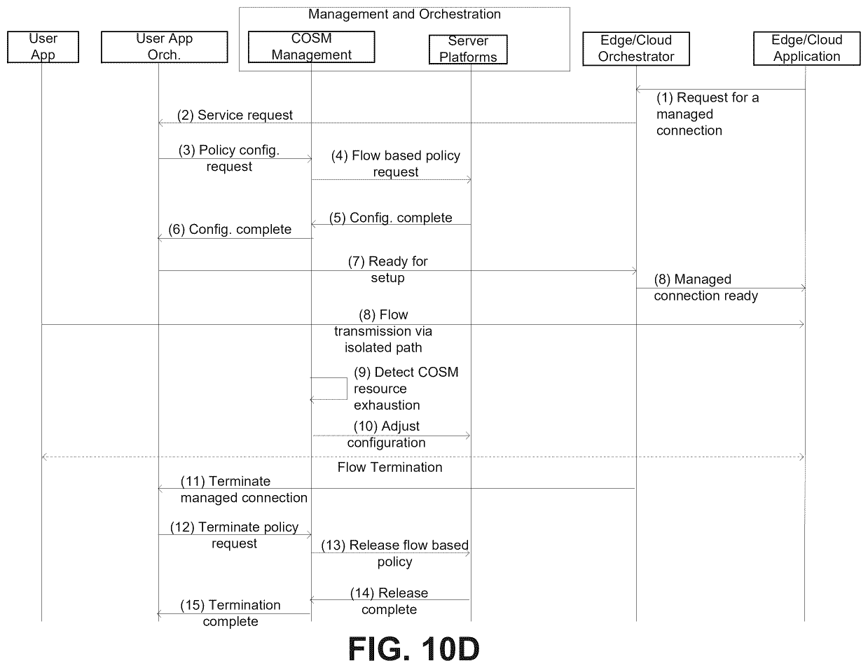

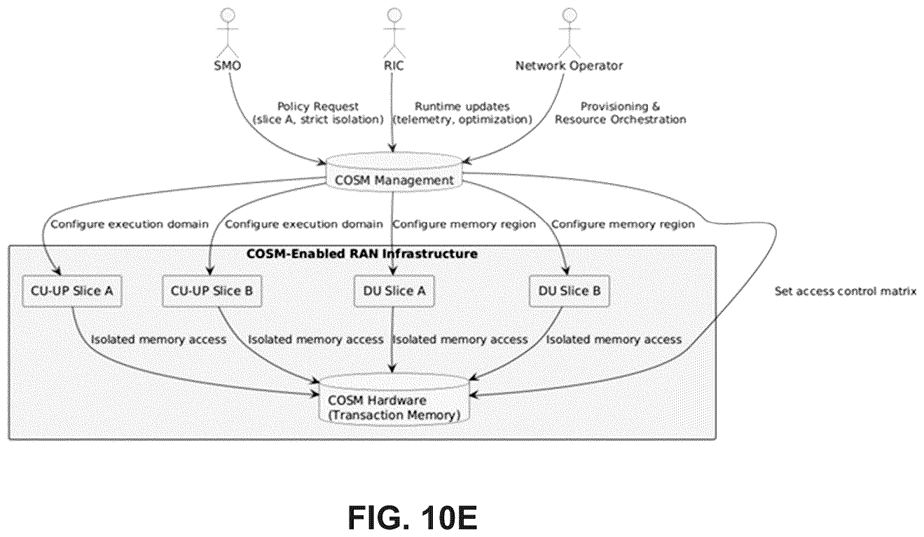

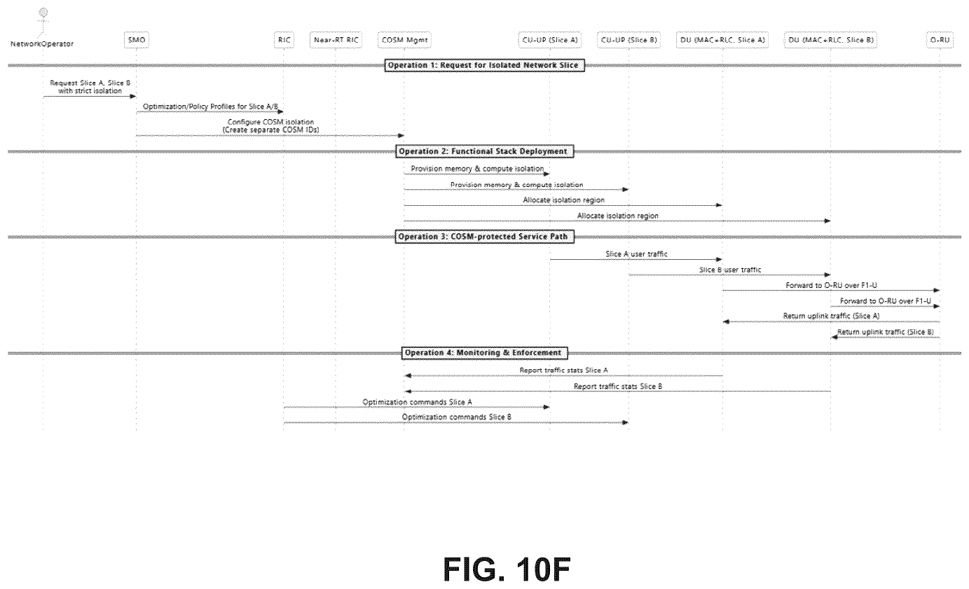

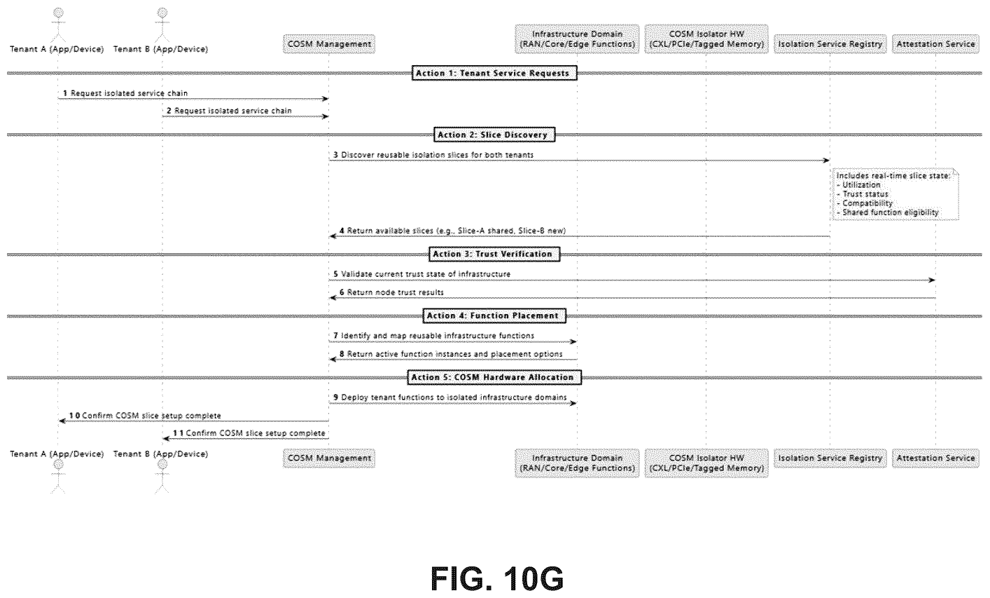

FIG. 10A illustrates an example sequence of operations that can be performed by examples described herein. At (1), AI application can request application orchestrator to access AI data from database. AI application can execute on a host (e.g., host 1 or host 2). Application orchestrator can execute on a computing platform connected COSM and hosts 1 and 2. Application orchestrator can execute on a same host (e.g., host 1 or host 2) that executes AI application. At (2), application orchestrator can validate the access request against configured security policies for reading or modifying the AI data.

At (3), COSM device and policy engine can determine access level for AI application from a configuration of multi-level data access controller. COSM device and policy engine can execute on ESMD or COSM control plane functions. Multi-level data access controller can execute on ESMD or COSM control plane functions. At (4), multi-level data access controller can return access permissions (high, medium, least, or none) for the AI application.

At (5), according to an access permission level for the AI application, multi-level data access controller can fetch data from AI database stored in COSM. At (6), COSM can return authorized data subset. If the request is not permitted, data that meets the permitted level of access is returned. For example, if the permission level permits access to all requested data, the provided data can be as requested. For example, if the permission level permits access to less than the requested data, the provided data can be less than the requested data. For example, if the permission level permits access to none of the requested data, the provided data can be garbage data or no data. At (7), COSM device and policy engine can forward retrieved data, if any, to orchestrator. At (8), orchestrator can forward requested data, if any, to AI application.

At (9), AI application can perform AI model execution by requesting feedforward AI data selection. At (10), feedforward AI data selector can provide appropriate data to AI application and AI application can perform inference operations on data using the weights provided from COSM.

FIG. 10B depicts a sequence diagram for the end-to-end operations of COSM-enabled secure Mixture of Experts (MoE) training and access control that can be performed by examples described herein. At (1), user 1 (e.g., operator or tenant) can request user application executed by host 1 to access AI weight data from database stored in COSM. At (2), user application executing on host 1 can request verification of access to weight data for a particular MoE. At (3), COSM isolation layer (e.g., COSM) can determine access level for the AI application from a configuration of authorization and policy engine. At (4), authorization and policy engine can return access permissions for the access (e.g., granted level of access (high, medium, low, no access) or deny). At (5), based on granted access, COSM isolation layer can request to retrieve weight data from COSM. For example, if access is not permitted, then dummy or garbage data can be returned. At (6), COSM can transfer the requested weights to COSM isolation layer. At (7), authorization and policy engine can transfer the requested weights to the requesting user application executing on host 1.

At (8), user application executing on host 1 can request an incremental training platform executing on host 2 to perform incremental training on the training data. At (9), an incremental training platform executing on host 2 can request training data from COSM isolation layer.

At (10), COSM isolation layer (e.g., COSM) can determine access level for training data from a configuration of authorization and policy engine. At (11), authorization and policy engine can return access permissions for the access (e.g., granted level of access (high, medium, low, no access) or deny) to COSM isolation layer. At (12), based on granted access, COSM isolation layer can retrieve requested training data from memory. At (13), COSM can provide training data, to the extent permitted by the access permission, to COSM isolation layer. For example, if access is not permitted, then dummy or garbage data can be returned.

At (14), COSM isolation layer can transfer authorized training data for incremental training to incremental training platform executing on host 2. At (15), after training using the training data, the incremental training platform executing on host 2 can provide updated weights to COSM.

At (16), COSM isolation layer can request authorization and policy engine to validate the updated weights to determine if the updated weights can be stored in COSM. At (17), COSM isolation layer can approve or reject the request based on an applicable policy. An applicable policy can identify a user application that is permitted to modify weights and store modified weights to COSM. At (18), based on approval to store the updated weights, COSM isolation layer can store the updated weights in COSM. Based on denial to store the updated weights, COSM isolation layer may discard or delete the updated weights and inform an administrator. At (19), COSM can confirm storage of the updated weights. At (20), COSM isolation layer can notify incremental training platform of successful model update.

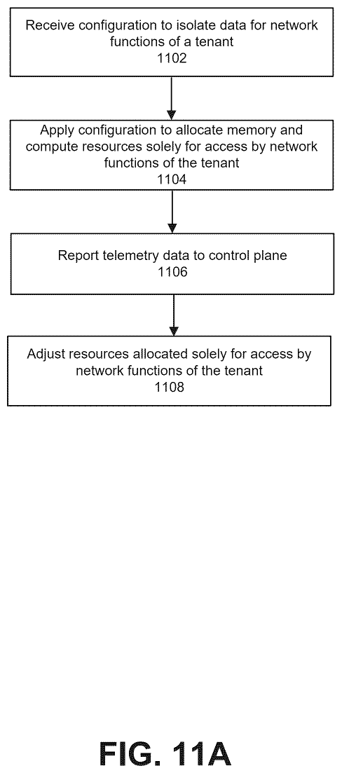

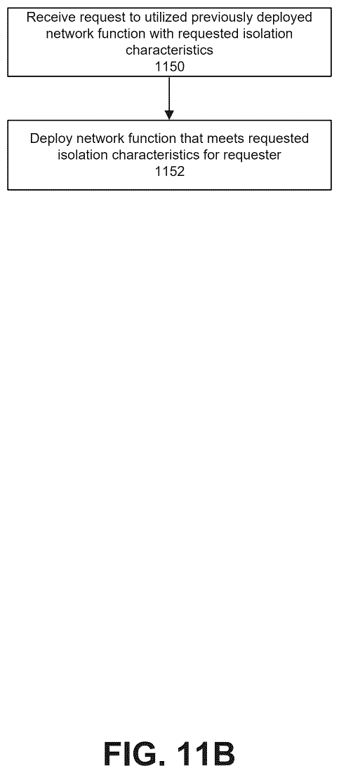

FIG. 11 depicts an example process. The process can be performed by a COSM device or other circuitry described herein. At 1102, a configuration that specifies a level of permitted read and write accesses by particular tenants or applications is applied. The configuration can grant a tenant or application complete access to trained weights or training data, partial access to trained weights or training data, or no access to trained weights or training data. The configuration can specify that a tenant or application is permitted to modify trained weights or not permitted to modify trained weights. At 1104, a request to access or to modify trained weights or training data can be received. At 1106, a determination can be made as to whether the request is permitted to be performed by the memory device based on the configuration. To the extent permitted, at 1108, the trained weights or training data can be accessed or modified. For example, if the configuration permits full access to trained weights or training data, the requested trained weights or training data can be provided. For example, if the configuration permits partial access to trained weights or training data, partial requested trained weights or training data can be provided. For example, if the configuration permits modification to trained weights or training data, trained weights or training data can be modified. At 1110, based on the request not being permitted based on the configuration, the request can be denied. In addition, an error or message can be issued to an administrator or orchestrator to indicate unauthorized access was requested.

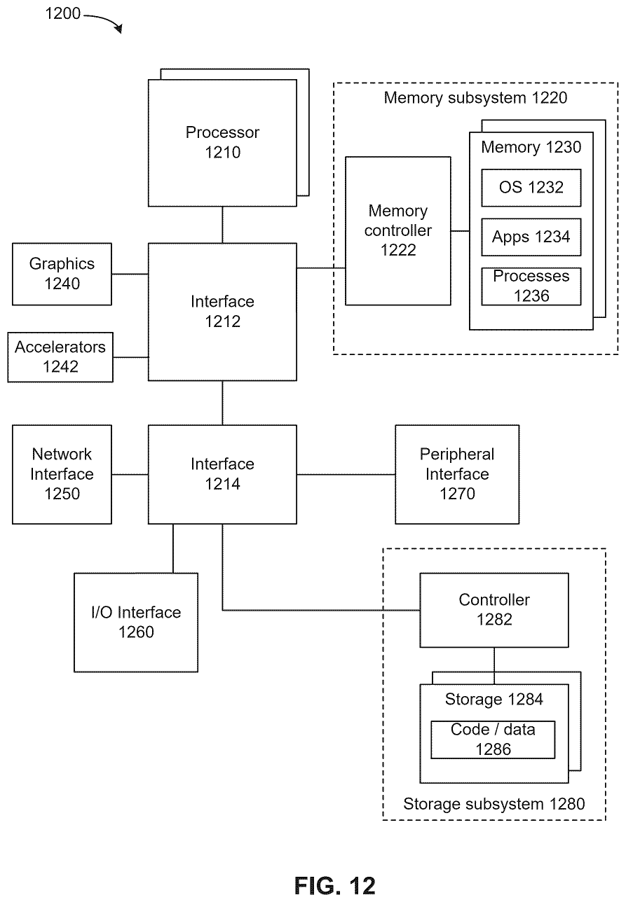

FIG. 12 depicts a system. In some examples, circuitry of system 1200 can be used to execute AI applications that perform training or inference, as described herein. System 1200 includes processor 1210, which provides processing, operation management, and execution of instructions for system 1200. Processor 1210 can include any type of microprocessor, central processing unit (CPU), graphics processing unit (GPU), XPU, processing core, or other processing hardware to provide processing for system 1200, or a combination of processors. An XPU can include one or more of: a CPU, a graphics processing unit (GPU), general purpose GPU (GPGPU), and/or other processing units (e.g., accelerators or programmable or fixed function FPGAs). Processor 1210 controls the overall operation of system 1200, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1200 includes interface 1212 coupled to processor 1210, which can represent a higher speed interface or a high throughput interface for system components that needs higher bandwidth connections, such as memory subsystem 1220 or graphics interface components 1240, or accelerators 1242. Interface 1212 represents an interface circuit, which can be a standalone component or integrated onto a processor die. Where present, graphics interface 1240 interfaces to graphics components for providing a visual display to a user of system 1200. In one example, graphics interface 1240 generates a display based on data stored in memory 1230 or based on operations executed by processor 1210 or both. In one example, graphics interface 1240 generates a display based on data stored in memory 1230 or based on operations executed by processor 1210 or both.

Accelerators 1242 can be a programmable or fixed function offload engine that can be accessed or used by a processor 1210. For example, an accelerator among accelerators 1242 can provide data compression (DC) capability, cryptography services such as public key encryption (PKE), cipher, hash/authentication capabilities, decryption, or other capabilities or services. In some cases, accelerators 1242 can be integrated into a CPU socket (e.g., a connector to a motherboard or circuit board that includes a CPU and provides an electrical interface with the CPU). For example, accelerators 1242 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1242 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 1220 represents the main memory of system 1200 and provides storage for code to be executed by processor 1210, or data values to be used in executing a routine. Memory subsystem 1220 can include one or more memory devices 1230 such as read-only memory (ROM), flash memory, one or more varieties of random access memory (RAM) such as DRAM, or other memory devices, or a combination of such devices. Memory 1230 stores and hosts, among other things, operating system (OS) 1232 to provide a software platform for execution of instructions in system 1200. Additionally, applications 1234 can execute on the software platform of OS 1232 from memory 1230. Applications 1234 represent programs that have their own operational logic to perform execution of one or more functions. Processes 1236 represent agents or routines that provide auxiliary functions to OS 1232 or one or more applications 1234 or a combination. OS 1232, applications 1234, and processes 1236 provide software logic to provide functions for system 1200. In one example, memory subsystem 1220 includes memory controller 1222, which is a memory controller to generate and issue commands to memory 1230. It will be understood that memory controller 1222 could be a physical part of processor 1210 or a physical part of interface 1212. For example, memory controller 1222 can be an integrated memory controller, integrated onto a circuit with processor 1210.

Applications 1234 and/or processes 1236 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 1232 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 1200 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1200 includes interface 1214, which can be coupled to interface 1212. In one example, interface 1214 represents an interface circuit, which can include standalone components and integrated circuitry. In one example, multiple user interface components or peripheral components, or both, couple to interface 1214. Network interface 1250 provides system 1200 the ability to communicate with remote devices (e.g., servers or other computing devices) over one or more networks. Network interface 1250 can include an Ethernet adapter, wireless interconnection components, cellular network interconnection components, USB (universal serial bus), or other wired or wireless standards-based or proprietary interfaces. Network interface 1250 can transmit data to a device that is in the same data center or rack or a remote device, which can include sending data stored in memory. Network interface 1250 can receive data from a remote device, which can include storing received data into memory. In some examples, packet processing device or network interface device 1250 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 1200 includes one or more input/output (I/O) interface(s) 1260. I/O interface 1260 can include one or more interface components through which a user interacts with system 1200. Peripheral interface 1270 can include any hardware interface not specifically mentioned above. Peripherals refer generally to devices that connect dependently to system 1200.

In one example, system 1200 includes storage subsystem 1280 to store data in a nonvolatile manner. In one example, in certain system implementations, at least certain components of storage 1280 can overlap with components of memory subsystem 1220. Storage subsystem 1280 includes storage device(s) 1284, which can be or include any conventional medium for storing large amounts of data in a nonvolatile manner, such as one or more magnetic, solid state, or optical based disks, or a combination. Storage 1284 holds code or instructions and data 1286 in a persistent state (e.g., the value is retained despite interruption of power to system 1200). Storage 1284 can be generically considered to be a “memory,” although memory 1230 is typically the executing or operating memory to provide instructions to processor 1210. Whereas storage 1284 is nonvolatile, memory 1230 can include volatile memory (e.g., the value or state of the data is indeterminate if power is interrupted to system 1200). In one example, storage subsystem 1280 includes controller 1282 to interface with storage 1284. In one example controller 1282 is a physical part of interface 1214 or processor 1210 or can include circuits or logic in both processor 1210 and interface 1214.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 1200 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

In an example, system 1200 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: an interface coupled to a memory and circuitry, coupled to the interface, wherein the circuitry is to: based on receipt of a first request to access Mixture of Experts (MoE) artificial intelligence (AI) trained weight data from a process associated with a first tenant, apply a configuration to determine whether to permit the access to the trained weight data from a memory and based on a determination to permit the access to the trained weight data, permit the memory to provide trained weight data to the process, wherein: the process is to perform an AI inference operation using the trained weight data and a memory region of the memory is accessible to multiple processes of a tenant.

Example 2 includes one or more examples, wherein the configuration is to specify a level of access by the process and the level of access comprises at least two levels of access.

Example 3 includes one or more examples, wherein the at least two levels of access comprise: permit full dataset access, permit access to domain-specific datasets, or permit access to pre-processed feature data.

Example 4 includes one or more examples, wherein the circuitry is to: based on receipt of a second request to access data from the process, apply the configuration to determine whether to permit the access to the data and based on a determination to permit the access to the data, permit the memory to supply data to the process.

Example 5 includes one or more examples, wherein the circuitry is to: receive updates to the trained weight data based on training using the data and based on a determination to permit modification of the trained weight data, permit the memory to store the modified trained weight data.

Example 6 includes one or more examples, wherein the first request is received via an Ethernet-based protocol via a link according to one or more of: a Peripheral Component Interconnect Express (PCIe)-based, Compute Express Link (CXL)-based, or NVLink-based protocol.

Example 7 includes one or more examples, and includes the memory coupled to the interface.

Example 8 includes one or more examples, and includes at least one non-transitory computer-readable medium, comprising instructions stored thereon, that if executed by one or more processors, cause the one or more processors to: based on receipt of a first request to access Mixture of Experts (MoE) artificial intelligence (AI) trained weight data from a process associated with a first tenant, apply a configuration to determine whether to permit the access to the trained weight data from a memory and based on a determination to permit the access to the trained weight data, permit the memory to supply trained weight data to the process, wherein: the process is to perform an AI inference operation using the trained weight data and the memory is accessible to multiple tenants.

Example 9 includes one or more examples, wherein the configuration is to specify a level of access by the process and the level of access comprises at least two levels of access.

Example 10 includes one or more examples, wherein the at least two levels of access comprise: permit full dataset access, permit access to domain-specific datasets, or permit access to pre-processed feature data.

Example 11 includes one or more examples, and includes instructions stored thereon, that if executed by one or more processors, cause the one or more processors to: based on receipt of a second request to access data from the process, apply the configuration to determine whether to permit the access to the data and based on a determination to permit the access to the data, permit the memory to supply data to the process, wherein the process is to update the trained weight data based on training using the data.

Example 12 includes one or more examples, and includes instructions stored thereon, that if executed by one or more processors, cause the one or more processors to: receive updates to the trained weight data based on training using the data and based on a determination to permit modification of the trained weight data, permit the memory to store the modified trained weight data.

Example 13 includes one or more examples, and includes a method that includes: based on receipt of a first request to access Mixture of Experts (MoE) artificial intelligence (AI) trained weight data from a process associated with a first tenant, applying a configuration to determine whether to permit the access to the trained weight data from a memory and based on a determination to permit the access to the trained weight data, permitting the memory to provide trained weight data to the process, wherein: the process performs an AI inference operation using the trained weight data and the memory is accessible to multiple tenants.

Example 14 includes one or more examples, wherein the configuration specifies a level of access by the process and the level of access comprises at least two levels of access.

Example 15 includes one or more examples, wherein the at least two levels of access comprise: permit full dataset access, permit access to domain-specific datasets, or permit access to pre-processed feature data.

Example 16 includes one or more examples, and includes based on receipt of a second request to access data from the process, applying the configuration to determine whether to permit the access to the data and based on a determination to permit the access to the data, permitting the memory to supply data to the process.

Example 17 includes one or more examples, and includes receiving updates to the trained weight data based on training using the data and based on a determination to permit modification of the trained weight data, permitting the memory to store the modified trained weight data.

What is claimed is:

1. An apparatus comprising:
an interface coupled to a memory and
circuitry, coupled to the interface, wherein the circuitry is to:
based on receipt of a first request to access Mixture of Experts (MoE) artificial intelligence (AI) trained weight data from a process associated with a first tenant, apply a configuration to determine whether to permit the access to the trained weight data from a memory and
based on a determination to permit the access to the trained weight data, permit the memory to provide trained weight data to the process, wherein:
the process is to perform an AI inference operation using the trained weight data and
a memory region of the memory is accessible to multiple processes of a tenant.

2. The apparatus of claim 1, wherein the configuration is to specify a level of access by the process and the level of access comprises at least two levels of access.

3. The apparatus of claim 2, wherein the at least two levels of access comprise: permit full dataset access, permit access to domain-specific datasets, or permit access to pre-processed feature data.

4. The apparatus of claim 1, wherein the circuitry is to:
based on receipt of a second request to access data from the process, apply the configuration to determine whether to permit the access to the data and
based on a determination to permit the access to the data, permit the memory to supply data to the process.

5. The apparatus of claim 1, wherein the circuitry is to:
receive updates to the trained weight data based on training using the data and
based on a determination to permit modification of the trained weight data, permit the memory to store the modified trained weight data.

6. The apparatus of claim 1, wherein the first request is received via an Ethernet-based protocol via a link according to one or more of: a Peripheral Component Interconnect Express (PCIe)-based, Compute Express Link (CXL)-based, or NVLink-based protocol.

7. The apparatus of claim 1, comprising the memory coupled to the interface.

8. At least one non-transitory computer-readable medium, comprising instructions stored thereon, that if executed by one or more processors, cause the one or more processors to:
based on receipt of a first request to access Mixture of Experts (MoE) artificial intelligence (AI) trained weight data from a process associated with a first tenant, apply a configuration to determine whether to permit the access to the trained weight data from a memory and
based on a determination to permit the access to the trained weight data, permit the memory to supply trained weight data to the process, wherein:
the process is to perform an AI inference operation using the trained weight data and
the memory is accessible to multiple tenants.

9. The computer-readable medium of claim 8, wherein the configuration is to specify a level of access by the process and the level of access comprises at least two levels of access.

10. The computer-readable medium of claim 9, wherein the at least two levels of access comprise: permit full dataset access, permit access to domain-specific datasets, or permit access to pre-processed feature data.

11. The computer-readable medium of claim 9, comprising instructions stored thereon, that if executed by one or more processors, cause the one or more processors to:
based on receipt of a second request to access data from the process, apply the configuration to determine whether to permit the access to the data and
based on a determination to permit the access to the data, permit the memory to supply data to the process, wherein the process is to update the trained weight data based on training using the data.

12. The computer-readable medium of claim 9, comprising instructions stored thereon, that if executed by one or more processors, cause the one or more processors to:
receive updates to the trained weight data based on training using the data and
based on a determination to permit modification of the trained weight data, permit the memory to store the modified trained weight data.

13. A method comprising:
based on receipt of a first request to access Mixture of Experts (MoE) artificial intelligence (AI) trained weight data from a process associated with a first tenant, applying a configuration to determine whether to permit the access to the trained weight data from a memory and
based on a determination to permit the access to the trained weight data, permitting the memory to provide trained weight data to the process, wherein:
the process performs an AI inference operation using the trained weight data and
the memory is accessible to multiple tenants.

14. The method of claim 13, wherein the configuration specifies a level of access by the process and the level of access comprises at least two levels of access.

15. The method of claim 14, wherein the at least two levels of access comprise: permit full dataset access, permit access to domain-specific datasets, or permit access to pre-processed feature data.

16. The method of claim 13, comprising:
based on receipt of a second request to access data from the process, applying the configuration to determine whether to permit the access to the data and
based on a determination to permit the access to the data, permitting the memory to supply data to the process.

17. The method of claim 16, comprising:
receiving updates to the trained weight data based on training using the data and
based on a determination to permit modification of the trained weight data, permitting the memory to store the modified trained weight data.
